(19) United States
(12) Patent Application Publication
(10) Pub. No.: US 2006/0074356 A1
(43) Pub. Date: Apr. 6, 2006

(54) Probe module for treating prostate diseases and portable prostate medical treatment apparatus

(75) Inventor: Min-Hwa Lee, Seoul (KR)

Correspondence Address: Jenkens & Gilchrist, a Professional Corporation, Suite 900, 901 15th Street, Washington, DC, 20005, US

(73) Assignee: Healthpia America Co., Ltd., Newark, NJ (US)

(21) Appl. No.: 11/283,944

(22) Filed: Nov. 22, 2005

Related U.S. Application Data
(63) Continuation of application No. PCT/KR03/01928, filed on Sep. 19, 2003.

(30) Foreign Application Priority Data
May 23, 2003 (KR) 10-2003-0033119

(51) Int. Cl. A61H 1/00

(52) U.S. Cl. 601/3

(57) ABSTRACT

A prostate treatment probe includes a first wireless communication unit capable of communicating with a corresponding external wireless communication unit, a probe controller for receiving a first control signal to control a prostate heat treatment operation from the external wireless communication unit through the first wireless communication unit, and a heat generator for generating corresponding prostate treatment heat in response to the first control signal.

The present invention claims the benefit of international patent application number PCT/KR2003/001928 in Korea filed on Sep. 19, 2003 and Korean patent application no. 10-2003-0033119 filed on May 23, 2003, which are both hereby incorporated by reference in their entirety.

### BACKGROUND OF THE INVENTION

1. Field Of The Invention

The present invention relates to a medical treatment device, and more particularly to a probe for treating prostate diseases and a portable prostate medical treatment apparatus.

2. Discussion of the Related Art

Interest in self-health is currently on the rise. The desire of users (for example, patients) to be able to simply perform medical treatment or measurement by themselves anywhere and at anytime as well as to continuously observe their current body conditions has been growing. The idea of incorporating additional circuits into a battery pack has been proposed in order to increase the functions of mobile communication terminals. Japanese Patent Publication No. 9-270836 published on Oct. 14, 1997 discloses an additional circuit of a radio receiver circuit embedded in a battery pack, which is detachably coupled to a mobile communication terminal. Korean Patent Publication No. 2001-19664, filed by Kim, Tea-Jin et al., and published on Mar. 15, 2001, describes an audio reproducing device that includes an MP3 codec and a flash memory module incorporated into a battery pack of a mobile communication terminal, which is controlled by a user interface of the mobile communication terminal.

The present applicant has observed that the incorporation of additional functions into a battery pack makes it possible to implement a large number of functions easily without hardware modification to the mobile communication terminal. The present applicant has also noticed that daily and continuous treatment is important for successful medical treatment, such as for skin beautification, and that data collection is important for a successful medical diagnosis, such as measuring body fat based on bioimpedance. Thus, the present Applicant has filed Korean Patent Application Nos. 2002-53004, 2002-52996, 2002-52995, and 2002-52994 on Sep. 3, 2002 which describe battery pack devices that are coupled to mobile communication terminals. These devices support low frequency treatment, ultrasonic cosmetic treatment, bioimpedance measurement, etc. Such devices include the necessary probes and driving circuits related thereto within the battery pack of the mobile communication terminal. These devices communicate with the main body of a mobile communication terminal and control the circuits inside the battery pack through an application program executed in the mobile communication terminal so as to operate the additional functions.

The prostate is one of the accessory organs that allows reproduction in cooperation with the testicle. The prostate produces about 35% of the liquid component of semen, and the produced prostate liquid supplies the nutrients to the sperm. In addition, the prostate prevents ejaculated semen from being thick to increase the sperm mobility and improve the sperm fertilizability. In addition, since it is alkaline, the prostate liquid neutralizes the high acidity of the fallopian tube, and thus assists the sperm in safely passing through the fallopian tube to meet and fertilize an ovum. The prostate is a chestnut-sized soft organ located just below the bladder in males and has a through hole in the center thereof. Since the urethra passes through the hole of the prostate, if there is a disorder in the prostate, it leads to urination disorder and may also cause sexual dysfunction.

Typical prostate diseases are prostatic hypertrophy, prostatitis and prostatic carcinoma. The prostatic hypertrophy is a disease caused by fatty substances accumulated on the prostate organ, and makes it difficult for middle-aged and older males to urinate, and can cause a number of urological problems. Various kinds of treatment methods have been developed and used to treat prostatic hypertrophy, and typical treatment methods up to now may be classified into three types, such as heat, physical, and injection therapies.

Prostate heat therapy treats the prostate by generating and applying heat within a specific temperature range of 36° C. to 45° C. to a portion of a prostate. Normal cells are killed at a temperature of about 45° C., while tumor cells are killed around at a relatively low temperature around 42.5° C. because they are sensitive to heat. The maintenance of temperature between 42.5° C. and 45° C. thus allows the normal cells to survive while killing the tumor cells. This is the principle used in prostate heat therapy. Prostate heat therapy is mainly used for treatment of nonbacterial prostatitis, and as circumstances require, it may be additionally used also in bacterial prostatitis to improve symptoms.

As discussed above, prostate heat therapy is used in the treatment of nonbacterial prostatitis, but it is sometimes utilized in even bacterial prostatitis for symptom improvement. Five to six treatment sessions are usually employed in which one session corresponds to treatment performed for 60 minutes at a temperature of 43° C. Such a treatment regiment shows excellent remedy efficiency in that symptoms are improved in 66% of patients, and the number of white cells in the prostate liquid is reduced in 77% of the patients. indoors. It is thus impossible for patients to go on about their normal daily activities as usual while wearing a prostate treatment probe. Further, since it has a wire cable connection, the prior art device causes an unfavorable appearance or impression. Furthermore, it is impossible for patients to receive professional prostate treatment according to their individual conditions unless they are treated directly by their physician.

### SUMMARY OF THE INVENTION

Accordingly, the present invention is directed to a probe for treating prostate diseases and a portable prostate medical treatment apparatus that substantially obviate one or more of the problems due to limitations and disadvantages of the related art.

An object of the present invention is to provide a prostate treatment probe and a portable prostate treatment device, whereby it is possible to minimize the burden on a user in wearing a prostate probe.

Another object of the present invention is to provide a prostate treatment probe and a portable prostate treatment device that provide professional and continuous prostate treatments to patients according to their individual conditions.

Another object of the present invention is to provide a prostate treatment probe and a portable prostate treatment device in which the prostate probe is separate from a main body.

Another object of the present invention is to provide a portable prostate treatment device in mobile communication terminal that minimize changes to the mobile communication terminal.

Another object of the present invention is to provide a prostate treatment probe and a portable prostate treatment device in which patients receive professional prostate treatment pattern information according to their individual conditions from a prostate treatment data center through a wireless data communication function supported by a mobile communication terminal.

Another object of the present invention is to provide a prostate treatment probe and a portable prostate treatment device in which both heat treatment and electric stimulation treatment that are used in parallel to perform prostate treatment.

Another object of the present invention is to economically implement a prostate treatment probe and a portable prostate treatment device, while minimizing changes to the existing hardware of a mobile communication terminal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a prostate treatment probe includes a first wireless communication unit capable of communicating with a corresponding external wireless communication unit, a probe controller for receiving a first control signal to control a prostate heat treatment operation from the external wireless communication unit through the first wireless communication unit, and a heat generator for generating corresponding prostate treatment heat in response to the first control signal.

In another aspect, a portable prostate treatment device includes a main body and a prostate treatment probe communicating wirelessly with each other, wherein the prostate treatment probe includes: a first wireless communication unit for communicating wirelessly with the main body; a probe controller for receiving a first control signal for controlling a prostate heat treatment operation from the main body through the first wireless communication unit; and a heat generator for generating corresponding treatment heat in response to the first control signal, and the main body includes: a user operating unit; a display unit; a second wireless communication unit for communicating wirelessly with the prostate treatment probe; and a main body controller for outputting operating guide information through the display unit.

In another aspect, a portable nerve/muscle treatment device includes a battery pack detachably coupled to a main body of a mobile communication terminal, the battery pack including: a communication interface for interfacing with the main body; a second wireless communication unit for communicating wirelessly with the prostate treatment probe; and a pack controller for transmitting a first control signal for controlling a prostate heat treatment operation to the prostate treatment probe through the second wireless communication unit in response to a prostate heat treatment operation command from the main body through the communication interface, and a prostate treatment probe including: a first wireless communication unit for communicating wirelessly with the battery pack; a probe controller for receiving the first control signal for controlling a prostate heat treatment operation from the battery pack through the first wireless communication unit, and controlling the prostate heat treatment operation; and a heat generator for generating corresponding treatment heat.

In yet another aspect, a portable prostate treatment device comprising a battery pack device detachably coupled to a main body of a mobile communication terminal, the battery pack device includes a power supply terminal through which power is supplied to the main body of the mobile communication terminal, at least one battery cell for supplying DC power to the power supply terminal, a communication interface for interfacing with the main body, a wireless communication unit for communicating wirelessly with a probe, and a pack controller for transmitting a first control signal for controlling a prostate heat treatment operation to the prostate treatment probe through the wireless communication unit in response to a prostate heat treatment operation command from the main body.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic view showing a prostate treatment device in the prior art.

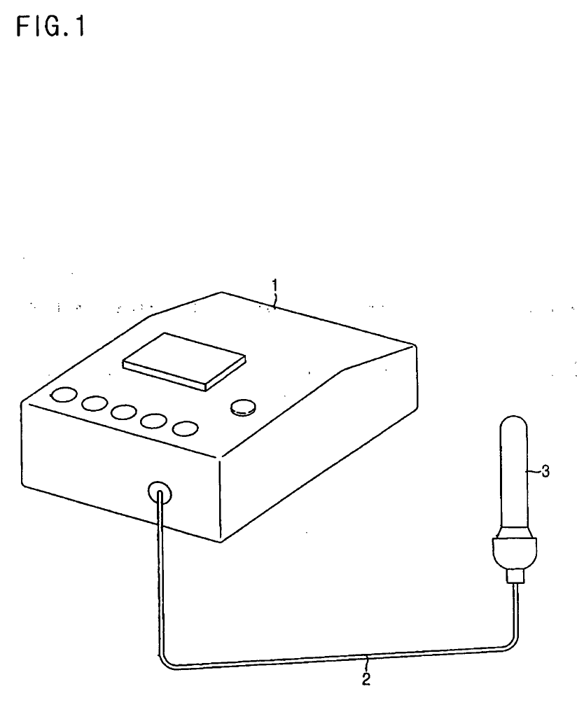

FIG. 2 illustrates a prostate treatment probe module and a mobile communication terminal according to embodiments of the present invention.

FIG. 3 is a block diagram of a portable prostate treatment device according to an embodiment of the present invention.

FIG. 4 is a block diagram of a portable prostate treatment device according to another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

The present Applicant has studied how to minimize the burden on users wearing a prostate probe, provide convenient control of the probe and allow patients the freedom to go on about conducting their daily activities while maintaining professional and continuous prostate treatment according to their individual conditions. As a result, the present Applicant has developed a prostate probe that is separate from a mobile communication terminal but controlled by the mobile communication terminal by having wireless communication between the prostate probe and the mobile communication terminal. Changes to the mobile communication terminal are minimized by providing an additional circuit within a battery pack. Thus, patients can receive professional prostate treatment pattern information according to their individual conditions from a prostate treatment data center through a wireless data communication function supported by the mobile communication terminal.

The prostate probe can provide heat as discussed above. However, a nerve/muscle treatment method is widely used in rehabilitation treatment as well as in the recovery of injured nerves, including a pelvic nerve, and in the treatment of frigidity, sexual dysfunction, urinary incontinence, pain alleviation, constipation, fecal incontinence, etc. One nerve/muscle treatment method is the electrical stimulation method, in which electrical stimulation is applied to a muscle that is no longer under voluntary motor control due to nerve injury, etc., so as to cause motion thereof. The intensity of the electrical stimulation with respect to time is suitably controlled to produce specific movement in order to achieve motor recovery. Another nerve/muscle treatment method is a therapeutic electrical stimulation method that simply repeats contraction and relaxation of the muscle.

The nerve/muscle treatment requires an electrode that is brought into contact with a nerve/muscle of interest in the human body. The electrode emits an electrical signal and/or detects an induced voltage signal. Such a treatment method using an electrode is classified into two types. One type is an insertion electrode that is inserted into a body cavity such as a sphincter in the hip (the anus) or a vagina of a female. The other type is an attachment electrode that is attached onto the skin.

None of the prior art has proposed the combined use of heat treatment and electric stimulation treatment in performing prostate treatment. The combined use of heat treatment and electric stimulation treatment has a high remedy efficiency compared to when only the heat treatment is used. The combined use of the two treatments may not cure prostate diseases, but it can prevent the recurrence of some prostate diseases and alleviate pain caused by most prostate diseases.

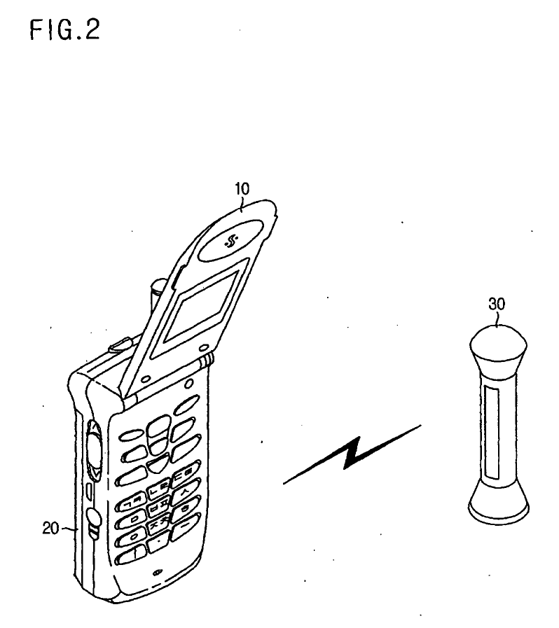

FIG. 2 illustrates a prostate treatment probe and a mobile communication terminal according to embodiments of the present invention. As shown in FIG. 2, the mobile communication terminal according to embodiments of the present invention includes a main body 10, and a battery pack 20 detachably coupled to the main body 10. According to one embodiment of the present invention, the battery pack 20 receives a command to perform an operation from the main body 10 of the mobile communication terminal, and transmits a control signal for controlling the received operation wirelessly to a prostate treatment probe module 30. According to another embodiment of the present invention, the main body 10 of the mobile communication terminal directly transmits the operation control signal wirelessly to the prostate treatment probe module 30.

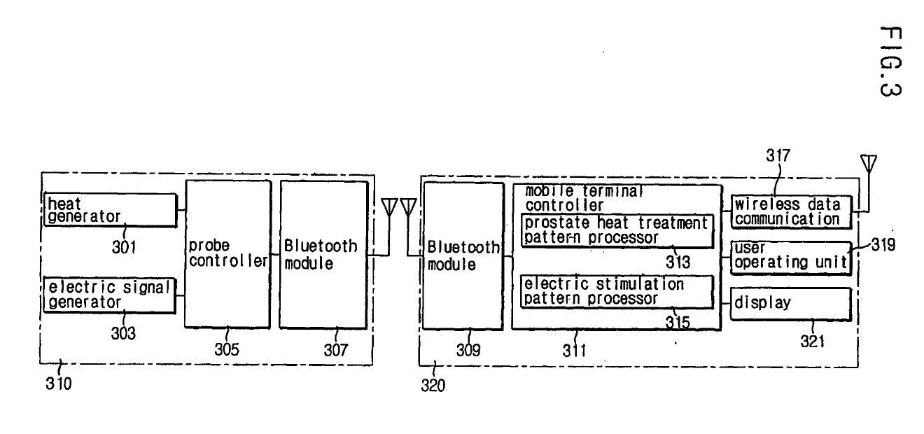

FIG. 3 is a block diagram of a portable prostate treatment device according to an embodiment of the present invention. As shown in FIG. 3, a prostate treatment probe 310 includes a first wireless communication unit 307 capable of communicating with a corresponding external wireless communication unit 309; a probe controller 305 for receiving a control signal for controlling a prostate heat treatment operation from the external wireless communication unit 309 through the first wireless communication unit 307, a heat generator 301 connected to the probe controller 305 for generating corresponding treatment heat in response to the control signal for controlling the prostate heat treatment, and an electric signal generator 303 connected to the probe controller 305 for generating corresponding an electric signal heat in response to the control signal for controlling the prostate electric signal treatment.

A description of a prostate treatment probe will now be given according to an embodiment of the present invention, with reference to the illustration of FIG. 2 and the block diagram of FIG. 3. The prostate treatment probe 30 is inserted into a body cavity of a patient to both generate and apply heat treatment onto a portion of the prostate. The prostate treatment probe 30 includes a body having a circular rod shape, and at least one exit prevention protrusion provided on a peripheral surface of the body. The first wireless communication unit 307 provided in the prostate treatment probe 310 of the prostate treatment probe 30 may be a Bluetooth module. The following description will be given based upon the first wireless communication unit 307 being a Bluetooth module. The Bluetooth module 307 is for performing wireless communication with a corresponding external Bluetooth module. In the embodiment of FIG. 3, the Bluetooth module performs wireless communication with the Bluetooth module 309 provided in the mobile communication terminal 320.

The probe controller 305 receives a control signal for controlling a heat treatment operation, which is transmitted wirelessly from the corresponding external Bluetooth module 309 through the first Bluetooth module 307, and controls the heat generator 301. The probe controller 305 may be implemented by another software module in the same signal processor as that of the Bluetooth module 307.

The heat generator 301 generates a corresponding heat treatment according to an operation instruction from the probe controller 305. Various circuit technologies for generating heat treatment can be utilized in the art of prostate treatment devices. For example, the heat generator 301 may be a voltage generator circuit and a heat generator element. The heat generator element may be an electric resistance hot wire, an electromagnet assembly or a piezoelectric element. Thus, it is possible to reduce the burden on a user in wearing a prostate treatment probe, since an interface with the outside is implemented through wireless communication rather than through a cable typically employed in the prior art.

In addition or in the alternative, the probe controller 305 can receive a control signal for controlling an electric stimulation operation from the external wireless communication unit 309 through the first wireless communication unit 307. The probe controller 305 controls the electric stimulation operation of the prostate treatment probe 310. A stimulation signal generator 303 for generating a corresponding electric stimulation signal is activated by the probe controller 305 in response to the control signal.

The stimulation signal generator 303 may include an electric stimulation generator circuit and an electrode located on the outside of the prostate treatment probe 310 (not shown). The electric stimulation generator circuit may be implemented by a combination of elements including a D/A converter, a gain controller, a noise filter, an amplifier and a potential transformer. A method for implementing such an electrical stimulation generator circuit is known in the art of nerve/muscle treatment device fabrication, and a detailed description thereof will thus be omitted. The electrode has an electric conductive property and is provided on the peripheral surface of a main body having a circular rod shape shown in FIG. 2, and outputs an electric stimulation signal generated by the electric stimulation generator circuit to a portion of the prostate.

Since an interface with the outside is implemented through wireless communication rather than through a cable unusually employed in the prior art, it is possible to reduce the burden on a user in wearing a prostate treatment probe, and it also allows a combined use of heat and electric stimulation in performing prostate treatment. The prostate treatment probe 310 is for body cavity insertion that includes a main body having a circular rod shape (refer to FIG. 2) and at least one exit prevention protrusion (refer to FIG. 2) provided on the peripheral surface of the main body, and in addition, the first wireless communication unit 307, the probe controller 305 and the generators 301 and 303 are embedded in the main body. Since only two elements, one element for an analog circuit required for prostate treatment and the other for wireless communication with the outside, are embedded in the prostate treatment probe module, and the entirety of a housing of the prostate treatment probe module is inserted into the body cavity, which reduces the burden of wearing the module is minimized so that typical daily activities can occur.

Although not shown, the probe module 310 includes a battery, such as a rechargeable battery, a replaceable battery or replaceable battery together with a secondary rechargeable battery. A manual power switch is available to block the power when the prostate treatment probe 310 is not in use. Alternatively, a microprocessor integrated within the probe controller 305 can monitor the prostate treatment probe 310 through the Bluetooth module 307, and when it determines that the prostate treatment probe 310 is not in use, the probe controller 305 shifts its power mode to control power supplied to each part in the device so that power consumption is minimized.

The portable prostate treatment device according to an embodiment of the present invention includes a main body 320 and a probe module 310 communicating wirelessly with each other. The probe module 310 includes a first wireless communication unit 307 for communicating wirelessly with the main body 320; a probe controller 305 for receiving a control signal for controlling a prostate heat treatment operation from the main body 320 through the first wireless communication unit 307, and controlling the prostate heat treatment operation; and a heat generator 301 for generating corresponding treatment heat in response to the control signal for controlling the prostate heat treatment operation. The main body 320 includes a user operating unit 319; a display unit 321; a second wireless communication unit 309 for communicating wirelessly with the prostate treatment probe 310; and a main body controller 311 for outputting operating guide information through the display unit 321, and transmitting the control signal for controlling the prostate heat treatment operation to the probe module 310 through the second wireless communication unit 309, according to the selection of a user operating signal input from the user operating unit 319.

The second wireless communication unit 309 provided in the main body 320 may be a Bluetooth module. The following description will be given when a Bluetooth module is used as the wireless communication unit 309. The Bluetooth module 309 provides a wireless link that allows data communication with a corresponding external Bluetooth module 307 provided in the probe module 310. The Bluetooth communication supports a point-to-point connection and a multipoint connection between devices in a local area (less than about 10 m) through frequency hopping CDMA communication. Transfer rates may be as high as 1 Mbps, and the data transmission is performed through ACL (Asynchronous ConnectionLess) and SCO (Synchronous Connection Oriented) links. In embodiments of the present invention, the wireless link may also be implemented through one of serial port profiles supported by the Bluetooth, for example through a LAN access profile or a CT profile. The Bluetooth module has already been commercialized and developed fully before the filing date of the present invention, and Bluetooth modules currently provided have a small size suitable for very small portable devices. The adoption of a Bluetooth module as a communication link is advantageous in that it minimizes the probability of data errors between medical devices due to electromagnetic interference. In addition, since Bluetooth modules are expected to be widely spread among small-size consumer devices, the adoption of a Bluetooth module will also make it easier to connect with other devices.

The main body controller 311 outputs operating guide information through the display unit 321, and transmits the control signal for controlling the prostate heat treatment operation to the probe module 310 through the Bluetooth module 309, according to the selection of a user operating signal input from the user operating unit 319. Since, in the actual implementation, the Bluetooth module 309 is implemented by a signal processor and a software module, the main body controller 311 may also be implemented physically by another software module in the same signal processor as that of the Bluetooth module 309. The main body 320 can further includes a prostate heat treatment pattern processor 315 that has information of one or more prostate heat patterns and provides corresponding heat treatment pattern information according to a control of the main body controller 311.

In embodiments of the present invention, the term “prostate heat treatment pattern” refers to as information such as an optimal heating temperature and a heating maintenance time stored for each case of an affected prostate part. Thus, the user can select an optimal heat treatment pattern according to his or her prostate condition. In addition, the user can receive treatment in various types of treatment patterns by using the portable prostate treatment device having the features described above.

The main body 320 further includes an electric stimulation pattern processor 315 that has information of one or more electric stimulation patterns and provides corresponding electric stimulation pattern information according to a control of the main body controller 311. The electric stimulation pattern processor 315 stores the information of electrical stimulation patterns of various forms that can be used for electrical stimulation signals. For example, a pulse wave may have various forms, and a sinusoidal wave may have full and half waveforms, etc. In addition, the electric stimulation pattern processor 315 can store a current or voltage pulse. Accordingly, the user can perform prostate treatment by using treatment heat and electric stimulation in parallel.

The pattern processors 313 and 315 described above may be implemented by a software module executed in a microprocessor, and provide corresponding pattern information in response to a control signal from the main body controller 311. The technology employed for implementing such pattern processors 313 and 315 is known in the art of manufacturing prostate treatment devices and nerve/muscle treatment devices. In a supplementary aspect of the present invention, the main body 320 is a mobile communication terminal.

The main body controller 311 may be implemented by a software module that is implemented in a microprocessor embedded in a mobile communication terminal. Improved CDMA integrated circuits, for example Qualcomm's MSM chips, each include a high performance microprocessor embedded therein. This microprocessor may be programmable through an external bus or a serial communication link. The programming environment of mobile communication terminals has been dramatically developed recently, so as to provide a development environment similar to a personal computer, and also provide a programming environment based on a virtual machine such as a GVM (General Virtual Machine). Operation control processes associated with prostate treatment performed by the main body controller 311 can be realized easily by using such a programming environment.

The main body controller 311 informs the user of a menu selection list associated with prostate treatment through the display unit 321. When a user operating signal is received from the user operating unit 319, the controller 311 transmits a corresponding operation command to the prostate treatment probe 310 wirelessly through the Bluetooth module 309. Accordingly, when it is provided with a local area wireless communication unit such as a Bluetooth module, the mobile communication terminal can serve as a main body of the portable prostate treatment device. Thus, the prostate treatment device can be combined with a mobile communication terminal that is easy to carry and that the user always carries. Such an arrangement allows easy portability, easy activity, convenient operation, and continuous treatment while conducting daily activities.

In a supplementary aspect of the present invention, the second wireless communication unit 309 is an external unit connected to a communication connector (not shown) of the mobile communication terminal. Although the Bluetooth module 309 may be embedded in the mobile communication terminal, alternatively, an external Bluetooth adapter may be utilized in such a manner that it is installed on an IF connector provided in the mobile communication terminal. Accordingly, even when the mobile communication terminal does not include a local wireless communication unit embedded therein, the mobile communication terminal can be utilized as the main body of the portable prostate treatment device by connecting an external Bluetooth module to a communication connector, for example a serial communication connector, provided by the mobile communication. Thus, the mobile communication terminal can receive the pattern information from a host computer (not shown) through the wireless data communication unit 317 and then provided the pattern information through the Bluetooth module 309.

The wireless data communication unit 317 may be a mobile communication processor, which includes a mobile communication processor 317 that processes a signal transmitted and received to and from a base station (not shown). The mobile communication processor 317 wirelessly processes the signal transmitted and received to and from the base station, demodulates the received signal wirelessly processed, and modulates a signal to be transmitted. The mobile communication processor 317 performs the modulation/demodulation operations in a predetermined mobile communication scheme, and, for example, may perform CDMA modulation/demodulation operations such as channel coding/decoding, orthogonal coding/decoding, etc. The mobile communication processor 317 also handles data transmission and reception to and from a wireless data communication network (for example, a wireless Internet server) associated with the mobile communication network. In addition, as circumstances require, the wireless data communication unit 317 may be a wireless LAN communication unit. In this case, the wireless communication is performed in a more restricted region.

The main body controller 311 controls the wireless data communication unit 317 to gain access to a previously appointed host computer through a wireless data communication network such as wireless Internet. When the connection with the host computer has been established, the main body controller 311 transmits the user's ID and secret number to the host computer to perform an authentication process thereof, and receives professional prostate treatment pattern information according to the individual conditions of patients from the host computer. The host computer is operated by a prostate treatment data center and holds data of various prostate treatment patterns. The prostate treatment data center may be operated by a specific hospital, and as circumstances require, it may be operated by a medical content provider associated with a number of hospitals. Although not shown, the main body 320 of a mobile communication terminal may further include a speaker and a microphone for voice communication, and a voice coder for audio compression/decompression, which are commonly included in general mobile communication terminals.

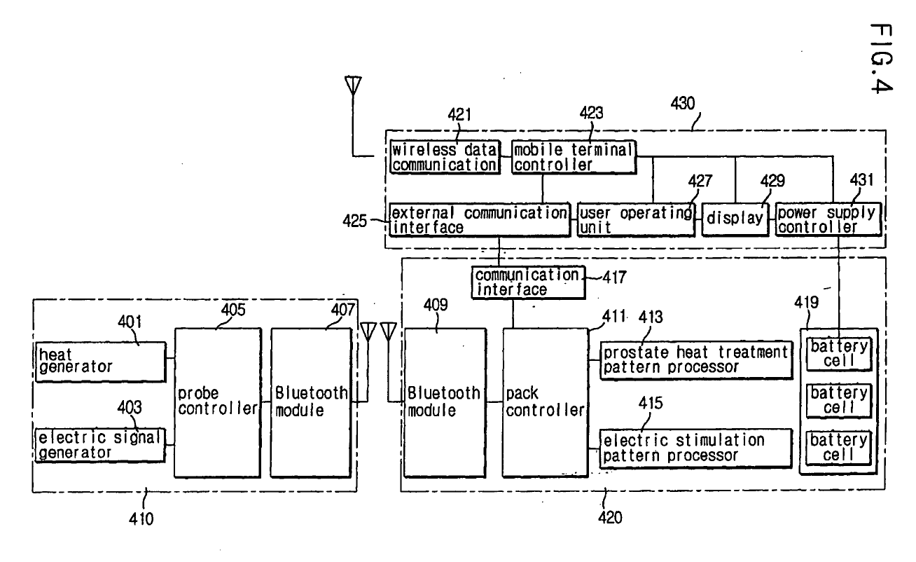

FIG. 4 is a block diagram showing another embodiment of a portable prostate treatment device according to the present invention. The following description will be given with reference to FIGS. 2 and 3. Descriptions of elements shown in FIGS. 2 and 3 will be omitted in describing FIG. 4 for simplicity.

As shown in FIG. 4, a portable prostate treatment device according to an embodiment of the present invention includes a prostate treatment probe 410, and a battery pack 420 detachably coupled to a main body 430 of a mobile communication terminal. The prostate treatment probe 410 includes a first wireless communication unit 407 for communicating wirelessly with the battery pack 420; a probe controller 405 for receiving a control signal for controlling a prostate heat treatment operation from the battery pack 420 through the first wireless communication unit 407, and controlling the prostate heat treatment operation; and a heat generator 401 for generating corresponding treatment heat in response to the control signal. The battery pack 420 includes a communication interface 417 for interfacing with the main body 430 of a mobile communication terminal; a second wireless communication unit 409 for communicating wirelessly with the probe module 410; and a pack controller 411 for transmitting a corresponding control signal for controlling a prostate heat treatment operation to the prostate treatment probe 410 through the second wireless communication unit 409, in response to a prostate heat treatment operation command input from the main body 430 through the communication interface 417. The probe module 410 has the same configuration as the probe module 310 of FIG. 3, and a description thereof will thus be omitted.

The communication interface 417 provided in the battery pack 420 is a USB port, which is physically implemented as connection points on a coupling surface of the battery pack 420 to be combined with the main body 430. The connection points can be arranged near a power supply terminal (not shown). A main chip adopted in a mobile phone improved recently, for example Qualcomm's MSM chip, supports a USB interface therein. If a user joins the battery pack 420 and the main body 430 of the mobile communication terminal together in a general manner, two interfaces, one being provided on the coupling surface of the battery pack 420 and the other provided on a corresponding coupling surface (not shown) of the mobile communication terminal, are connected to each other, so that the communication interfaces are conveniently physically coupled to each other.

The wireless communication unit 409 for communicating wirelessly with the prostate treatment probe 410 can be a Bluetooth module. The Bluetooth module 409 provides a wireless link that allows data communication with a corresponding external Bluetooth module 407 in the prostate treatment probe 410.

The pack controller 411 receives an operation command signal according to the selection of a user manipulation signal from the main body 430 through the communication interface 417, and transmits the operation control signal wirelessly to the prostate treatment probe 410 through the Bluetooth module 409. In addition, the pack controller 411 receives prostate treatment pattern information and electric stimulation pattern information through the communication interface 417, and transfers this information to a prostate heat treatment pattern processor 413 and a electric stimulation pattern processor 415, respectively.

The embodiment of FIG. 4 is characterized in that the prostate heat treatment pattern processor 413 and the electric stimulation pattern processor 415 are provided within the battery pack 420. The two pattern processors 413 and 415 have been sufficiently described with reference to FIG. 3, and a further description thereof will thus be omitted.

A battery cell unit 419 includes a plurality of battery cells, and supplies power to the main body 430 of the mobile communication terminal through a power supply terminal (not shown).

An external communication interface 425 provided in the main body 430 corresponds to the communication interface 417 in the battery pack 420 described above. Both of the interfaces are implemented according to the same protocol, and are physically implemented as connection points having shapes corresponding to each other, so as to be combined together (not shown).

A mobile communication terminal controller 423 informs a user of a menu selection list associated with prostate treatment through a display unit 429. When a user operating signal is received from a user operating unit 427, the controller 423 transmits a corresponding operation command to the battery pack 410 through the external communication interface 425. In response to this command, the pack controller 411 transmits a control signal for controlling an electrical stimulation operation, or a prostate heat treatment operation in parallel with the electric stimulation operation, to the prostate treatment probe 410 wirelessly through the Bluetooth module 409.

The mobile communication terminal controller 423 controls a wireless data communication unit 421 to gain access to a previously appointed host computer through a wireless data communication network such as wireless Internet. When the connection with the host computer has been established, the terminal controller 423 transmits the user's ID and secret number to the host computer to perform an authentication process thereof, and receives professional prostate treatment pattern information according to the individual conditions of patients from the host computer. A power supply controller 431 processes DC power supplied from the battery pack 420 to convert it to a required voltage, and then stabilizes and supplies it to each element in the main body 430.

As apparent from the above descriptions, according to embodiments of the present invention, it is possible to reduce the burden on a user in wearing a prostate treatment probe, since an interface with the outside is implemented through wireless communication, not through a cable usually employed in the prior art. Further, it is possible to perform prostate treatment by using both heat treatment and electric stimulation in parallel.

Since only two elements, one element for an analog circuit required for prostate treatment and the other for wireless communication with the outside, are embedded in the prostate treatment probe, and the entirety of a housing of the prostate treatment probe is inserted into a body cavity, the burden of wearing the module is minimized, and free daily activities can occur. A user can select an optimal heat treatment pattern according to his or her prostate condition. In addition, the user can receive treatment in various types of treatment patterns by using a portable prostate treatment device having the features described above.

When an embodiment of the present invention is provided with a local area wireless communication unit such as a Bluetooth module, a mobile communication terminal can serve as a main body of the portable prostate treatment device, so that the prostate treatment device is combined with a mobile communication terminal that is easy to carry and the user always carries, which allows easy portability, easy activity, convenient operation, and continuous treatment in conducting daily activities. Further, since the existing operating and display units of the mobile communication terminal are utilized, the implementation can be achieved at low cost. Even when there is no embedded local wireless communication unit, a mobile communication terminal may be utilized as the main body of the portable prostate treatment device. Since patients can receive corresponding prostate treatment pattern information from a prostate treatment data center through a wireless data communication function supported by a mobile communication terminal, it is possible for patients to perform professional prostate treatment according to their individual conditions.

A user interface for prostate treatment can be implemented easily in a mobile communication terminal, in the form of an application based on a virtual machine such as a GVM (General Virtual Machine). In addition, a portable prostate treatment device and a prostate treatment probe according to embodiments of the present invention can be utilized in treating and preventing prostate diseases in males, and can be also utilized in treating and preventing prostatic hypertrophy, prostatitis, prostate pain and prostatic carcinoma.

It will be apparent to those skilled in the art that various modifications and variations can be made in the probe for treating prostate diseases and portable prostate medical treatment apparatus of the present invention without departing from the spirit or scope of the invention. Thus, it is intended that the present invention cover the modifications and variations of this invention provided they come within the scope of the appended claims and their, equivalents.

What is claimed is:

1. A prostate treatment probe comprising:
a first wireless communication unit for communicating with a corresponding external wireless communication unit;
a probe controller for receiving a first control signal to control a prostate heat treatment operation from the external wireless communication unit through the first wireless communication unit; and
a heat generator for generating corresponding prostate treatment heat in response to the first control signal.

2. The prostate treatment probe according to claim 1, wherein the probe controller receives a second control signal for controlling an electric stimulation operation from the external wireless communication unit through the first wireless communication unit and the prostate treatment probe includes a stimulation signal generator for generating a corresponding electric stimulation signal in response to the second control signal.

3. The prostate treatment probe according to claim 1, comprising:
a body having a circular rod shape; and
at least one exit prevention protrusion provided on a peripheral surface of the body,
wherein the first wireless communication unit, the probe controller and the generators are within the body, the prostate treatment probe is for cavity insertion.

4. A portable prostate treatment device, comprising:
a main body and a prostate treatment probe communicating wirelessly with each other, wherein the prostate treatment probe includes:
a first wireless communication unit for communicating wirelessly with the main body;
a probe controller for receiving a first control signal for controlling a prostate heat treatment operation from the main body through the first wireless communication unit; and
a heat generator for generating corresponding treatment heat in response to the first control signal; and
the main body includes:
a user operating unit;
a display unit;
a second wireless communication unit for communicating wirelessly with the prostate treatment probe, and
a main body controller for outputting operating guide information through the display unit.

5. The portable prostate treatment device according to claim 4, wherein the main body includes a prostate heat treatment pattern processor that has information of one or more prostate heat treatment patterns and provides corresponding heat treatment pattern information.

6. The portable prostate treatment device according to claim 5, wherein the main body includes an electric stimulation pattern processor that has information of one or more electric stimulation patterns and provides corresponding electric stimulation pattern information.

7. The portable prostate treatment device according to claim 4, wherein the main body is a mobile communication terminal.

8. The portable prostate treatment device according to claim 7, wherein the second wireless communication unit is an external unit connected to a communication connector in the mobile communication terminal.

9. The portable prostate treatment device according to claim 7, wherein the mobile communication terminal receives the pattern information from a host computer through a wireless data communication unit.

10. A portable nerve/muscle treatment device, comprising:
a battery pack detachably coupled to a main body of a mobile communication terminal, the battery pack includes:
a communication interface for interfacing with the main body;
a second wireless communication unit for communicating wirelessly with the prostate treatment probe; and
a pack controller for transmitting a first control signal for controlling a prostate heat treatment operation to the prostate treatment probe through the second wireless communication unit in response to a prostate heat treatment operation command from the main body through the communication interface, and
a prostate treatment probe including:
a first wireless communication unit for communicating wirelessly with the battery pack;
a probe controller for receiving the first control signal for controlling a prostate heat treatment operation from the battery pack through the first wireless communication unit, and controlling the prostate heat treatment operation; and
a heat generator for generating corresponding treatment heat.

11. The portable prostate treatment device according to claim 10, wherein the probe controller in the prostate treatment probe receives a second control signal for controlling an electric stimulation operation from the battery pack through the first wireless communication unit, the prostate treatment probe further includes an electric stimulation generator for generating a corresponding electric stimulation signal in response to the second control signal, and the pack controller transmits the second control signal for controlling an electric stimulation operation to the prostate treatment probe through the wireless communication unit in response to an electric stimulation operation command input from the main body through the communication interface.

12. The portable prostate treatment device according to claim 11, wherein the battery pack includes an electric stimulation pattern processor that has information of one or more electric stimulation patterns and provides corresponding electric stimulation pattern information.

13. The portable prostate treatment device according to claim 12, wherein the pack controller in the battery pack receives an input of the pattern information wirelessly via the main body from a host computer through the communication interface.

14. The portable prostate treatment device according to claim 10, wherein the battery pack includes a prostate heat treatment pattern processor that has information of one or more prostate heat treatment patterns and provides corresponding heat treatment pattern information.

15. The portable prostate treatment device according to claim 13, wherein the pack controller in the battery pack receives an input of the pattern information wirelessly via the main body from a host computer through the communication interface, said pattern information being received wirelessly by the main body.

16. A portable prostate treatment device comprising a battery pack device detachably coupled to a main body of a mobile communication terminal, the battery pack device comprising:
a power supply terminal through which power is supplied to the main body of the mobile communication terminal;
at least one battery cell for supplying DC power to the power supply terminal;
a communication interface for interfacing with the main body;
a wireless communication unit for communicating wirelessly with a probe; and
a pack controller for transmitting a first control signal for controlling a prostate heat treatment operation to the prostate treatment probe through the wireless communication unit in response to a prostate heat treatment operation command from the main body.

17. The portable prostate treatment device according to claim 16, wherein the pack controller transmits a second control signal for controlling an electric stimulation operation to the prostate treatment probe through the wireless communication unit in response to an electric stimulation operation command input from the main body through the communication interface.

18. The portable prostate treatment device according to claim 16, wherein the battery pack device includes:
a heat treatment pattern processor that has information of one or more prostate heat treatment patterns and provides corresponding heat treatment pattern information in response to a prostate heat treatment operation command from the main body.

19. The portable prostate treatment device according to claim 17, wherein the battery pack device includes:
an electric stimulation pattern processor that has information of one or more electric stimulation patterns and provides corresponding electric stimulation pattern information in response to an electric stimulation operation command from the main body.

20. The portable prostate treatment device according to claim 16, wherein the pack controller receives an input of the pattern information through the communication interface, said pattern information being received wirelessly by the main body.
